(19) United States
(12) Patent Application Publication
(10) Pub. No.: US 2024/0330835 A1
(43) Pub. Date: Oct. 3, 2024

(54) Method, System and Computer Program Product for Assessing Labor Efficiency of Knowledge Work such as Software Development Work

(71) Applicant: minware Inc., Arlington, VA (US)

(72) Inventor: Kevin R. Borders, Arlington, VA (US)

(73) Assignee: minware Inc., Arlington, VA (US)

(21) Appl. No.: 18/192,953

(22) Filed: Mar. 30, 2023

(51) Int. Cl. G06Q 10/0639; G06F 8/77

(52) U.S. Cl. CPC G06Q 10/06398; G06F 8/77

(57) ABSTRACT

Method, system and computer program product for assessing labor efficiency of knowledge work such as software development work are provided. The method includes the step of receiving event data extracted from one or more data sources. The event data are related to activities conducted by knowledge workers to obtain event records. Each event record contains the identity of each knowledge worker associated with an event and either a time interval or a point in time when the event occurred. The method also includes calculating activity records associated with time intervals during a time period from the event records. The activity records contain information about what occurred based on the event records. The method further includes allocating work effort based on the time intervals from the activity records to associate a cost with the activities and to obtain an effort value indicating amount of effort for each time interval.

### TECHNICAL FIELD

At least one embodiment of the present invention generally relates to methods, systems and computer program products for assessing labor efficiency of knowledge work and, in particular, to software development work.

### Overview

For many types of organizations, labor costs are a significant expense. As such, it is important to understand whether labor is working efficiently to minimize the cost required to create valuable products and services for customers.

Assessing labor efficiency for modern knowledge work like software development can be much more difficult than assessing efficiency for more repetitive interchangeable tasks as done in traditional efficiency analysis in a manufacturing setting. Because software development and other knowledge work involve a lot of thinking, communicating, testing, and experimentation, it can be difficult to even know what people are working on at any given time.

One solution that has been employed for tracking work is to require workers to log their hours and the task they are working on during that time. While this provides the desired information, manually entering this information can have a significant cost itself. Furthermore, time logging data is likely to be coarse-grained and fail to capture activities that are only a few minutes, such as getting interrupted by answering an email. Finally, this type of collection is subject to human error in accurately remembering and describing work.

To address the limitations of manual time logging solutions, systems have been created for automatically attributing labor effort to particular tasks in a project management system. In a project management system, workers are assigned tasks with different identifiers and metadata indicating the larger initiative of which they are a part. This information can then be aggregated to determine the total level of effort going toward different objectives, which can be used to make accounting determinations about how much software development or other research and development expense should be recorded as a capital expenditure.

Data from other sources such as calendar, version control, document management, and communication systems can be used to augment information in the version control system itself and provide further evidence about what someone was working on at a particular time.

Despite the presence of existing methods for determining what people are working on, there is still a significant knowledge gap about whether workers are actually using their time efficiently. The fact that someone was assigned to a particular project does not provide information about the nature of the activities they were conducting during that period. Without more detail about the nature of activities, an analysis system cannot provide information about how much time was or was not used productively.

The following U.S. patents are related to at least one aspect of the present invention: U.S. Pat. Nos. 10,318,248, 10,860,314; 11,188,323; and 11,488,081.

### SUMMARY

An object of at least one embodiment of the present invention is to provide methods, systems and computer program products for assessing work effort or time efficiency by accurately calculating information about work activities at each time interval for each worker.

In carrying out the above object and other objects of at least one embodiment of the present invention, a method for assessing labor efficiency of knowledge work is provided. The method includes the steps of receiving event data extracted from one or more data sources. The data is related to activities conducted by knowledge workers to obtain event records. Each event record contains the identity of each worker associated with an event and either a time interval or point in time the event occurred. The method also includes calculating activity records associated with time intervals during a time period from the event records. The activity records contain information about what occurred based on the event records. Further, the method includes allocating work effort based on the time intervals from the activity records to associate a cost with the activities and an effort value indicating amount of effort for each time interval.

The method may further comprise the step of classifying the activity records.

The method may further comprise the step of enriching the activity records to compute additional information about the activities based on the level of effort that goes into the activities and activity metadata.

The method may further comprise the step of classifying the enriched activity records.

The method may further comprise presenting the classified activity records to a user.

The classified activity records may be presented to a user in the form of a report.

The classified, enriched activity records may be presented to a user in the form of a report.

The method may further comprise the step of processing the event data to add or change metadata related to each event to obtain preprocessed event data.

The step of producing activity records may be performed with the preprocessed event data.

The knowledge work may be software development work.

Further in carrying out the above object and other objects of at least one embodiment of the present invention, a system for assessing labor efficiency of knowledge work is provided. The system includes at least one hardware processor and at least one storage device coupled to the at least one hardware processor for storing instructions that are operable, when executed by the one or more hardware processors to cause the one more processors to perform operations. The operations include receiving event data extracted from one or more data sources. The data is related to activities conducted by knowledge workers to obtain event records. Each event record contains the identity of each worker associated with an event and either a time interval or a point in time when the event occurred. The operations also include calculating activity records associated with time intervals during a time period from the event records. The activity records contain information related to events that occurred during or near the time intervals. The operations further include allocating work effort based on the time intervals from the activity records to associate a cost with the activities and to obtain an effort value indicating amount of effort for each time interval.

The operations may further comprise classifying the activity records.

The operations may further comprise enriching the activity records to compute additional information about the activities based on the level of effort that goes into the activities and activity metadata.

The operations may further comprise classifying the enriched activity records.

The operations may further comprise presenting the classified activity records to a user.

The classified activity records may be presented to a user in the form of a report.

The classified, enriched activity records may be presented to a user.

The operations may further comprise processing the event data to add or change metadata related to each event to obtain preprocessed event data.

The operation of producing activity records may be performed with the preprocessed event data.

The knowledge work may be software development work.

Still further in carrying out the above object and other objects of at least one embodiment of the present invention, a computer readable storage medium is provided. The storage medium stores a program of instructions executable by a machine to perform operations. The operations include receiving event data extracted from one or more data sources. The data are related to activities conducted by knowledge workers to obtain event records. Each event record contains the identity of each worker associated with an event and also either a time interval or a point in time when the event occurred. The operations also include calculating activity records associated with time intervals during a time period from the event records. The activity records contain information about what occurred based on the event records. The operations also include allocating work effort based on the time intervals from the activity records to associate a cost with the activities and to obtain an effort value indicating amount of effort for each time interval.

The knowledge work may be software development work.

### BRIEF DESCRIPTION OF THE DRAWINGS

FIG. 1 is a block diagram, flow chart which illustrates the steps of a method of at least one embodiment of the present invention;

FIG. 2 is a schematic block diagram illustrating conventional hardware to perform the steps of a method of at least one embodiment of the present invention; and

FIGS. 3A through 3D are schematic views, partially broken away, of various screen shots which display exemplary time allocation reports provided by at least one embodiment of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

At least one embodiment of the current invention provides a method, system, and computer program for assessing work effort efficacy. It achieves this by accurately calculating information about both the task and activity occurring at each time interval for each worker, and then displaying that information via a user interface that helps visualize how much work effort is adding value for customers or contributing to team velocity.

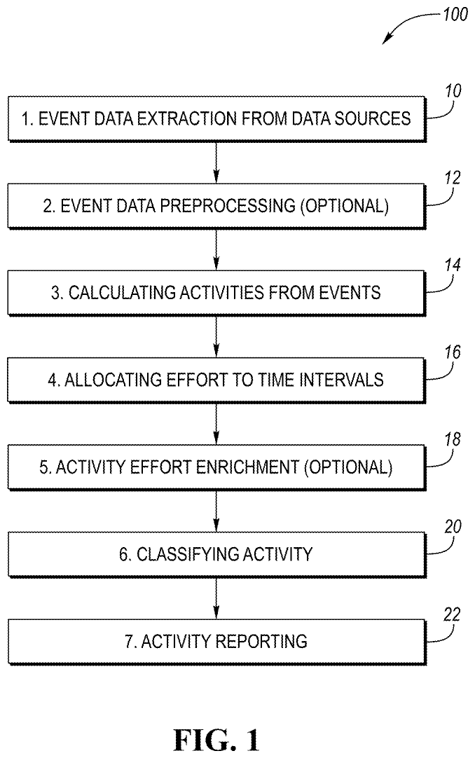

The remainder of this document describes the method, system, and computer program for assessing work effort efficacy. Each section of the document outlines the inputs, outputs, and processing procedures involved in a particular method step, which combine to take low-level information about worker activity from various data sources and produce higher-level reports about work time efficiency. The sequence of steps can be seen in FIG. 1.

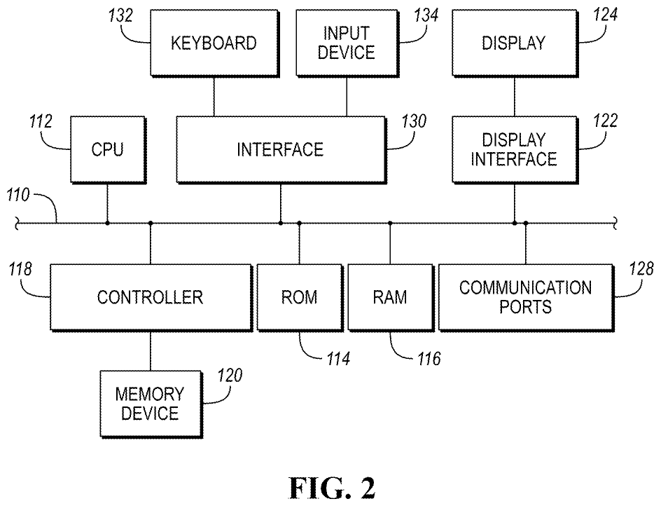

FIG. 2 depicts a block diagram of system hardware components that may be used to implement the various services and processing devices as discussed herein. A bus 110 serves as the main information highway interconnecting the other illustrated components of the hardware. A CPU 112 is a central processing unit of the system that performs calculations and logic operations required to execute one or programs. The CPU 112, alone or in conjunction with one or more of the other elements disclosed in FIG. 2, is a processing device, computing device or processor as such terms are used within this disclosure. Read only memory (ROM) 114 and random access memory (RAM) 216 constitute exemplary memory devices.

A controller 118 provides an interface between one or more optional tangible, non-transitory computer-readable memory devices 120 and the system bus 110. These memory devices 120 may include, for example, an external or internal DVD or CD ROM drive, a hard drive, flash memory, a USB drive or the like. As indicated previously, these various drives and controllers are optional devices. Additionally, the memory devices 120 may be configured to include individual files for storing any software modules or instructions, auxiliary data, common files for storing groups of results or auxiliary, or one or more databased for storing the result information, auxiliary data, and related information as discussed above.

Program instructions, software or interactive modules for performing any of the methods and systems as discussed herein may be stored in the ROM 114 and/or the RAM 116. Optionally, the program instructions may be stored on a tangible computer readable medium such as a compact disk, a digital disk, flash memory, a memory card, a USB drive, an optical disc storage medium, such as a Blu-Ray™ disc, and/or other recording medium.

An optional display interface 122 may permit information from the bus 110 to be displayed on a display 124 in audio, visual, graphic or alphanumeric format. Communication with external devices may occur using various communication ports 128. An exemplary communication port 128 may be attached to a communication network, such as the Internet or a local area network.

The hardware may also include an interface 130 which allows for receipt of data from input devices such as a keyboard 132 or other input device 134 such as a mouse, a joystick, a touch screen, a remote control, a pointing device, a video input device and/or an audio input device.

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

A “knowledge worker” is anyone who works for a living at the tasks of developing or using knowledge. For example, a knowledge worker might be someone who works at any of the tasks of planning, acquiring, searching, analyzing, organizing, storing, programming, distributing, marketing, or otherwise contributing to the transformation and commerce of information and those (often the same people) who work at using the knowledge so produced. The knowledge worker includes those in information technology fields, such as programmers, systems analysts, technical writers, academic professionals, researchers, and so forth. The term is also frequently used to include people outside of information technology.

1. Event Data Extraction from Data Sources

Referring to FIG. 1, a method of at least one embodiment of this invention is generally indicated at 100. A data extraction step 10 of the method 100 is performed for obtaining event information from data sources. This step 10 may take data from a variety of different source types and systems. The following list of data sources is meant to be explanatory and not intended to be exhaustive or limiting. At least one embodiment of the invention could be extended to benefit from any other sources of data related to activities conducted by individuals.

The following types of data sources are common sources that may be used to provide input events for at least one embodiment of the invention. The data extraction step involves collecting raw data from these systems, such as via an API or a file export, and then producing event records having either a time interval with a start and end time or a point in time, and metadata about the event that may include the identity of an individual associated with the event and other information about the type of the event.
Project management/ticket tracking systems—These systems contain a variety of information about individual activity related to tasks, bugs, etc. represented in tickets. They often have fields indicating when a ticket is assigned to an individual, when that ticket transitions to an in-progress state, and when it is marked completed or reassigned. Event records may be created for those in-progress time intervals. Furthermore, individuals may be able to comment or edit tickets, which constitute other types of activity at points in time when the comments or edits were made.
Version control and code review systems-One common type of event in a version control system is a change set or “commit”, which represents an update made by an individual at a point in time. This is a common type of event. There are also systems for reviewing code that allow people to add comments and take other structured actions like approving or denying a change request, which represent other events.
Document management systems and office applications-Similarly, systems for editing documents, spreadsheets, design files, and other artifacts often have data available that is analogous to a “commit” in a version control system, which includes information about what changed at a given point in time and who made the change, with varying levels of granularity available depending on the particular software in question. They may also have more limited information available, like just the name of the author and time of last update. These changes and any comments can be treated similarly to how they are handled in version control and code review systems.
File management and backup systems-Cloud file storage and management systems may separately record the author's identity, modification time, and version history for various files independently of the applications used to edit those files. They can be used as a source of change events for applications where the data is not provided or as convenient to gather as it is from file management or backup systems.
Calendar and scheduling systems—These systems hold information about planned meetings, appointments, and out-of-office time, which serve as interval-based events. Note that there may be some processing step to filter or ignore certain events either within the method described here or as a preprocessing step to handle events that aren't real activities, like “focus time” or “no meeting blocks.”
Communication tools, including direct messaging, group chat, and email-Various forms of communication tools have emerged beyond email. They typically have some form of user identity, content, and timestamp associated with their messages that can be used as input events.
Video and voice communication systems-Activity on these systems indicates active communication between people. It can be used to corroborate that meetings from calendar data sources actually happened, or on its own to indicate direct communication activity, including ad hoc events that were not in a calendar event.
Device-based activity tracking and keylogging systems—There are systems available that log detailed user activity relating to keystrokes, mouse movements, or other user input to a particular application or at a system-wide level on a computing device. Device agent software can also record activity at the file system or network level. This data can be used either directly as individual point-in-time events, or aggregated into time intervals during which there were multiple user input events.
Time tracking and HR systems—There are various ways that individuals can manually or automatically log when they are actively working, optionally indicating metadata about the particular activity or project they were working on. HR systems may also contain data about when employees take vacation time and are out of the office. This timing data can provide input events, which may also help with corroborating the start and end times of other activity.
Paging and notification systems-People who are responsible for handling time-sensitive requests-like software engineers when there is a system outage—may receive pages or notifications from a paging system. Furthermore, these systems often have an event status to indicate when an alert started and when it was closed by the person who received a page. Event information can be derived from this data either as point-in-time or interval event records depending on what information is recorded about the end time of a page. This data can also be combined with subsequent point-in-time events like code commits and emails, which are likely to be associated with responding to a page or alert.
Physical location information-Employee badges and mobile devices may register information about where a person is physically located at various points in time, including from badge swipes and wi-fi access point pings. Depending on the nature of their jobs, that can provide various information about what type of activity individuals are conducting at a point in time, and be used to corroborate or replace other data sources like when a person starts and ends their work day, whether they actually attended meetings on their calendar, etc.

### 2. Event Pre-Processing

Once events are extracted from various data sources, it may be beneficial in some embodiments of the invention to apply a pre-processing step (i.e., block 12 in FIG. 1) to the events to add or change metadata related to each event.

One common pre-processing step is to link identities in different data sources that represent the same person by providing a mapping of identities in various input data sources to a canonical identity. There are many ways to link identities and at least one embodiment of the invention does not rely on a particular identity linking method, but some common methods include exact matching on an email address, or exact or approximate matching on first/last/middle names. Another method that may be employed is to look at identities associated with data records from different sources that have other common identifiers, such as using code commits that reference a ticket ID to infer that the code author identifier should be linked to the ticket assignee identifier because they are likely the same person.

Another common preprocessing step is to extract references and links between data from different sources. Data records may contain full URIs of related data in other sources, or simply tokens in text that identify those records in other sources, such as a ticket identifier being placed in the title or body of a code change request or code commit message.

More advanced methods can be used to infer associations between data of different sources and include information about those associations as a pre-processing step. This can be done, for example, by analyzing text or keywords in meeting names, code comments, and ticket descriptions to determine whether they are likely to be related even if there isn't an explicit URI or identifier token link.

Individual events can also undergo preprocessing independently of events from other data sources. In some embodiments, code or text changes may be preprocessed to determine the type and nature of those changes. For example, different event metadata may be generated during a preprocessing step to indicate whether a change set deleted existing code, modified code, or wrote new code. The age and author of the code being modified may also inform the type of activity.

A preprocessing step for code/text changes could further analyze other attributes of removed or added code/text to derive other metadata about the change, such as if it is a bug fix, refactoring, new code, copied code, along with the programming language, framework, changes in complexity metrics, or other attributes. This list is meant to be illustrative rather than exhaustive, and at least one embodiment of the invention described here will work with any type of pre-processing methods that add information to events to help determine the nature of their underlying activity.

3. Calculating Activities from Events (i.e. Block 14 in FIG. 1)

### A. Overview

At least one embodiment of the invention allocates time periods to tasks and activities. The purpose of this is to determine the most appropriate task to which the individual's activity should be attributed, as well as metadata related to the most likely activity being conducted during a particular time interval given potentially inconsistent, incomplete, or overlapping records that exist from various input data sources.

### B. Inputs

The main input to this step or method is a plurality of event records from one or more data sources. Each event record contains the identity of the individual associated with the event. Multi-person events like meetings can be represented by multiple event records-one for each individual involved.

An optional auxiliary input to this method is a time period for which to compute output activity records. If omitted, the method may emit outputs spanning a range of activity relative to the time covered by the input event records.

Each event record must have either a time interval indicating a start and stop time, such as the start and end of a meeting, or a single point time representing when the event occurred, such as when an email was sent.

Event records may contain other metadata describing attributes of the event, which may be used to determine how much time to ascribe to the event. For example, indicating the word count in an email or number of code lines in a code change set may be helpful in accurately estimating the start time of those point-in-time events.

The metadata may also indicate the type of event, which may influence how activity time intervals are computed. For example, instant messages may take less time to compose on average than an email, so may have shorter intervals assigned to them. Different activity types may also be given different levels of precedence. For example, having a ticket marked “in progress” in a project management system for a week may take lower precedence than meetings that occur during that week, so event records for meetings will have that time allocated to them, while those meetings times will be cut out of the lower-precedence ticket time interval.

### C. Outputs

This method outputs activity records describing the tasks and activities conducted by individuals during different time periods.

Each record specifies the individual involved with the activity. Multiple people participating in similar activities (such as participating in the same meeting) will have separate activity records.

Each activity record should specify a time interval for the activity with a start time and an end time. Time intervals for output activity records may be limited in duration to only cover periods where the individual was likely to be actively working, such that the aggregate time spanned by all activity records in a time window is meant to reflect hours worked by the individual.

However, this method does not need to limit its output only to time intervals where the individual was likely to be actively working. In another embodiment, the method may output activity records spanning an entire time range such that there are no gaps in time (e.g., including nights and weekends). A subsequent method for computing the weighted level of effort associated with activity time intervals to compensate for time working versus not working or varying levels of work intensity is described herein.

This method may generate output activity records indicating “unknown”, “missing”, or “idle” time (referred to hereafter as empty time) to indicate that there was likely no activity or very little activity during certain intervals, or it may simply output activity records with gaps in between them to imply no/low activity periods.

If an optional entire time period is provided as an input, this method may truncate time intervals that span outside of this period, or create records to pad the start or end of the period with empty time.

Each activity record should specify at most one task identifier, and may omit a task identifier to indicate that the activity should not be attributed to a particular known task. The task identifier may link to an identifier in a project management or ticket tracking system. The task identifier will be derived from input event records related to tasks.

If an individual is working on multiple tasks during the same time period, or if the individual's activity should be amortized over multiple tasks, then this method may output multiple overlapping activity records-one for each task-optionally specifying an allocation ratio indicating the amount of effort during the time period that should be attributed to each task, which may add up to 100%, or less than 100% to indicate that a portion of the time in that interval should remain unallocated. Multiple activity records with optional weights may also be output for the same task if there are different types of activity occurring in parallel.

Finally, this method may include activity metadata related to the probable activity in the activity record outputs, or omit all activity metadata to indicate an “unknown”, “missing”, or “idle” activity. The activity metadata may contain information relating to the event records that serve as evidence of the activity. It may also indicate the type of activity, such as a meeting, writing code, or composing an email.

This method may output multiple activity records related to a single input event record. This is helpful for handling scenarios where there is one type of activity abbreviated by other shorter activities during its duration, such as meetings emails that occur during an otherwise contiguous block of work on a task.

Activity record outputs may contain information related to multiple input event records. This can be helpful, for example, if a meeting occurred during a time when an individual had an in-progress task assigned to them so that the record can include activity metadata relating to the meeting, while also allocating that activity to the assigned task.

The output activity records need not only contain information in their metadata related to input event records that occurred during the time interval specified in output activity record. This method may also reference event records occurring before or after a given time interval for generating activity metadata or the task allocation. For example, if an individual has no tasks that are assigned to them and marked in progress at the time of a code commit, but later in the day an assigned task transitions directly from “to-do” to “done”-indicating that it was not marked in-progress when work began-then the event record relating to the later task status transition may be referenced in the activity metadata and used as the source of the task identifier for the activity record.

### D. Method Implementation

Given the varied nature of input data from various types of systems and various providers of each type of system, there are many potential embodiments of the method for producing activity records from input event records. Some key attributes of potential embodiments of this method are now described. First, the nature of common input event types are described in more detail, then a method which can produce output activity records from these events is discussed.

### 1. Handling Point-in-Time Changes

One class of input event record is a point-in-time record indicating that an individual created some content, which may be entirely new content (e.g., in the case of an email or instant message), or a change set based off of existing content (e.g., a code commit or document edit). These types of events share similar properties and can be treated in a similar way. These are referred to as point-in-time changes.

First, these point-in-time changes usually have a single author, but can have multiple authors, for example if two people are working together on code edits. In this case, there would be multiple event records that may have metadata indicating that they are related.

These point-in-time changes also only indicate activity that occurred some time before their timestamp and not after.

For a given point-in-time change, there are a few possibilities for when the individual actually devoted effort to the change. First, it is possible that the individual started work right after the end of the previous event and kept working continuously until the point-in-time change, in which case the appropriate output activity record interval would span from the end of the previous event to the time of the point-in-time change.

It is also possible that there were intervening activities not present in any of the input data sources, such as someone stopping by to talk with the individual about an unrelated topic.

Finally, it is possible that work on the point-in-time change began prior to the previous event record, which is especially likely for larger and less frequent point-in-time-changes. For example, common sense dictates that a code commit having 1000 lines changed probably began before a 10-word instant message that was sent 5 minutes before the code commit.

While the end date of the final interval is clear with point-in-time changes, the difficult part is determining the appropriate starting time of work on the change, including whether it is punctuated by other activities. Going back to the instant message example, it's very likely that the instant message was sent in the middle of work on the code commit, but it's less obvious how much time should be allocated to the instant message.

### 2. Handling Meetings/Conversations

Another common type of input event record indicates active communication between two or more individuals, which could be a scheduled meeting or ad hoc phone call.

These types of event records have a defined start and end time so are typically straightforward to handle, though there are a few edge cases that require special handling by the method.

First, it is not always clear if someone attended a particular meeting because they may decide not to show up or attend without formally accepting an invitation. Moreover, people sometimes have invitations to overlapping meetings.

Finally, there may be other activity going on in the meeting if it is a working meeting where people are sending emails, collaborating on document edits, etc., in which case there may be point-in-time-changes during the time period of the meeting.

Embodiments of this method must decide what output activity records to output for meetings, if any, in these less straightforward scenarios.

### 3. Handling Task Assignment and In-Progress Status

Project management and ticket tracking systems can provide data about when tasks are assigned to individuals and when those tasks move to an “In progress” or to a “Done” status.

If there is only one in-progress task assigned to an individual, this is a strong indicator of the best task to allocate activity records to in the output. However, things may be more complicated if the individual is assigned to multiple in-progress tasks or no in-progress tasks.

In these cases, the method must decide which task is most likely to be the one associated with any activity, or if the activity record should not have any task associated with it.

### 4. Handling Activity Tracking or Rapid Point-in-Time Changes

Activity tracking systems that record user input events into a computing device are a highly reliable source of information due to their fine granularity. Rapid point-in-time change events like a chain of instant messages sent with only a several seconds between each one function in a similar way where it's extremely likely that the user was active and fully focused on the rapid events that occurred during the time period.

If this type of information is available, it is likely to be more accurate and comprehensive than data from other sources.

### 5. Handling Time Logs

Time log data is information reported manually by the individual about what they were working on and when. It can be more reliable than other data sources in some aspects, and less reliable in others. First, there may be a certain amount of information in human-recorded time logs that may not exist in other sources, like what the topic was of an ad hoc phone call and whether it was related to the task at hand. Time logs can also capture time spent just sitting and thinking about how to solve a problem that has no other evidence in data sources.

Time logs may also be inaccurate in a few ways. First, they rely on human memory and are subject to human error in recalling both the start time of the activity and what the task and activity type was during the period of the time log.

Finally, time logs only have limited granularity because people are not likely to record very brief activities like quickly responding to an instant message or briefly chatting with someone who walks by their desk.

### 6. Rule-Based Approaches

One way to implement the method is to use a rule-based approach for converting input event records to output activity records based on heuristics derived from domain knowledge or policies relating to the types of activity described above.

An example of a rule-based approach would be to say that all code commit event types represent an activity record with a start time at the end of the previous code commit, but not exceeding one day, or not going back before the start time of the current day, with the knowledge that individuals generally do not work more than one day on a single code commit, and generally will submit a code commit before working on the next one rather than working on multiple code commits in parallel.

Rules may also be applied to different event types to give them precedence or use them for corroboration. For example, meeting intervals may take precedence and cut into time intervals between code commits, because it is unlikely that individuals were working on the code commit during the time of the meeting. Time logs that coincide with in-progress status changes for assigned tickets may take precedence over time intervals derived from point-in-time code commits, which would otherwise take precedence without corroboration.

When there isn't an immediately preceding event to establish the start of an activity interval for a point-in-time-change, rules may also employ models of time spent for point-in-time changes. Those models may have fixed values based on activity type—for example, saying that instant messages should count as 30 seconds of activity if there's no more recent preceding event—or they may have variable models that depend on event attributes. For example, time spent on email without a recent preceding event could be modeled as a function of the word count

Any fixed or simple variable models employed by the method may be created without data based on domain expertise, or they may be the result of other data analysis or research on how long activities take based on their type and other variables, which may be general or specific to the organization.

Some embodiments of this method may also allow users of the method to configure parameters relating to rules based on their particular situation or policies. For example, users of the method may know that people in their organization follow unique work practices limiting time between code commits. Or, their accounting firm may provide limits on how much time before/after a task is marked in-progress would be allowable for attributing time to that task for the purposes of R&D tax credits.

### 7. Machine Learning Models

In addition to heuristics and rules dictating how to generate activity records from event records, the method may partly or entirely rely on one or more machine learning models.

Creating a model using machine learning in this case can use additional data, or it can be trained just using existing available event record data. In the case of the later, the algorithm can model things like how various metadata associated with code commits influences the time spent on those commits just using constraints based on assumptions, such as that the maximum amount of time spent on a commit is the time since the previous commit, but the actual time spent on the commit is unknown.

Another approach to training a model is to use more fine-grained data for training. For example, it might be feasible to ask people to log their time or deploy activity tracking systems on their devices to establish high-confidence training data about exactly when they were conducting various activities related to specific tasks. This data could then be used to label less granular data (like just code commits, calendar events, and ticket tracking data) to produce a machine learning model, which could then be applied to historical or other less granular data where better tracking is not available.

User feedback is another way to train learning algorithms. This can take many forms, but could mean asking people about specific data points to see if they are correct, or having people manually go through larger data sets to provide ground-truth labels for the machine learning algorithm.

### 8. Input Data Look-Ahead Window

Different embodiments of the method may require a certain amount of event record input data beyond the end of the output time period to execute, or may produce different results if data changes within a certain time frame past the end of the provided time period. The size of this time frame is referred to as the look-ahead window.

For example, if a ticket from a project management system is moved directly from a “to do” to a “done” state, bypassing the regular “in progress” status, then that may provide information about activity at an earlier time than the timestamp in that status change event. It may be beneficial to look at data for a certain amount of time into the future to enhance the accuracy of the method described herein.

At the same time, there are benefits to limiting the amount of time that future events can impact activity records in the current time period. For example, this is helpful for producing reports used for accounting, where a key requirement is that those reports are guaranteed not to change after the books have been “closed” for the time period in question.

The size of the look-ahead window effectively sets an upper bound on the amount of time that can be attributed to a point-in-time change. The reason for this is that the method may output some other activity record if it does not see any other events within the look-ahead window. Events that occur later after the end of the current look-ahead window can only impact resulting activity records up to the size of the look-ahead window prior to their occurrence.

Various embodiments of this method may have fixed or variable look-ahead windows apply constraints on the output data, though larger or different look-ahead windows can be used when training machine learning models to improve their accuracy.

### 9. Hybrid Approach

While some embodiments of the described method may use an entirely rule-based or entirely machine learning approach, a hybrid solution may be preferable. In a hybrid approach, certain rules may override model outputs, or models might be applied to compute time intervals for specific subsets of the input data-like how much time to ascribe to point-in-time changes based on their metadata and the individual author.

Either way, at least one embodiment of the invention is not tied to a particular implementation of the method for deriving activity records from event records, and can operate with any implementation of this method.

### 4. Allocating Effort to Time Intervals

### A. Overview

The method described in the previous section outputs activity records associated with time intervals during a time period. While it may be helpful to know when people were conducting various activities, associating a cost with those activities requires allocating individual effort to those time intervals. The next step (i.e., block 16 of FIG. 1) of the method of at least one embodiment of the invention is a method for allocating effort that was exerted by people to time periods.

### 1. Inputs and Outputs

The effort allocation method only requires one or more activity time intervals as an input. Other metadata associated with the activity time intervals, such as the individual conducting the activity, the type of activity, or the related task, are optional inputs to this method that may be used to improve accuracy, even though they are provided in the previously described method for generating activity records.

The effort allocation method will output a value indicating the amount of effort for each of the one or more provided activity time intervals. The effort output values can be expressed in units of work time such as person-hours, a percentage effort over some time period, or any other unit that is useful in representing labor resource allocation. Monetary compensation values may be derived from effort values by multiplying those effort values by worker compensation

In one embodiment of this method, there can be one output value for each of the one or more input time intervals representing a portion of effort that interval represents related to all the provided intervals. This can be used to allocate time within some time window by providing all the activity in that time window as inputs to the effort allocation method. The output allocation values can then be multiplied by labor costs during this time window to arrive at a cost associated with each input activity interval.

In another embodiment of this method, the output can be a unit of effort. This method of operation is useful because it requires no look-ahead to future time intervals to ascertain the effort allocated to the current interval. (In the embodiment that outputs the ratio of effort within a time window, that time window must be complete to know the correct values for earlier intervals in that time window.)

The embodiment where the method outputs a unit of effort without looking ahead can still be used to reliably allocate 100% of effort during some time period as long as it is guaranteed to output a fixed number of units over a given period of time (e.g., 5 work days every 7 calendar days), which can then be multiplied by compensation per time granularity (e.g., per work day). 100% allocation further requires that the input data is guaranteed to always cover 100% of the calendar time without any gaps or overlapping (i.e., any time intervals without data are provided as “empty” activity interval inputs to fill in gaps).

Still other embodiments may output a variable number of work units per time period, which may be appropriate for hourly workers, shift workers, or workers with any form of compensation that varies.

While some embodiments may reliably allocate 100% of effort over some time interval, that is not a requirement. At least one embodiment of the invention will also work even if the effort units don't directly correspond to compensation or to 100% allocation of effort. Over- or under-allocating effort can be fixed by later summing all the allocations together and dividing them by the total to arrive at a 100% allocation. Or, allocation inaccuracies can be accumulated and reconciled at a later time (e.g., to evenly amortize vacation days over the year). Finally, over- or under-allocation need not ever be reconciled and at least one embodiment of the invention can still produce useful output overall.

### 2. Allocation Modeling

This section describes how the effort allocation method uses a model to compute effort values for its input time intervals.

a. Fixed Models

In a naive implementation, work effort can be allocated evenly across all provided time intervals. However, this can lead to undesirable results because people do not work 24 hours a day, and may not actively be working during some of the provided input intervals, particularly those that span non-work hours. This can lead to especially inaccurate results for input time intervals that are less than a few days, but span nights or weekends, which represent a majority of the calendar work week despite the fact that people may not work at all during this time.

Another implementation would be to just hard-code a rule-based work schedule like 9 AM-5 PM Monday through Friday. This could be okay if workers stick to a strict schedule, but very few modern knowledge workers do, which would lead to inaccuracies. Furthermore, even if a fixed work schedule accurately reflects when people are working, their level of energy may vary throughout the day, so this allocation may not accurately reflect the deployment of their effort.

b. Schedule Models

A more accurate effort allocation model can be trained based on historical data to determine how much effort is appropriate to allocate to each interval.

One approach for such training is to build a schedule that reflects the amount of effort observed historically during certain time periods of the day and days of the week, month, and/or year. The time periods may have any granularity, but, for example, a schedule model may contain a list of values for each hour in a week. Those values can indicate the number of work hours to allocate to an interval covering that time period, with the total sum of all 168 (24*7) hour values for the week adding up to the total number of work hours, such as 40 hours.

With such a schedule model, this method can then process input time intervals by multiplying each time period in those intervals by the ratio of work time to calendar time to generate work effort totals for each provided interval.

There are multiple ways to train such a schedule model based on previous activity from various data sources. One potential method is to look at point-in-time events to observe the density of those events during previous times to infer an individual, team, or organization schedule. The benefit of this approach is that it naturally accounts for variations in levels of productivity within active work hours.

Another approach would be to use high-confidence information such as time logs or data from activity monitors to construct a schedule based on historical activity. The benefit of this approach is that there is visibility into start times and work gaps that you don't get just by looking at point-in-time events.

Note that a schedule model can be agnostic to any information other than the start and end times of activities. It does not need to know anything about the nature of the activity to produce an effort allocation because allocations are determined based on expected time working.

c. Input-Variable Models

Another approach for allocating work effort to activity intervals is to consider information from the activity interval metadata rather than simply looking at the schedule.

In this type of input-variable model, the allocation method may use the type of activity or attributes of the activity to compute the level of effort to allocate to that activity's time interval.

For example, activity backed by high-confidence data about whether a user was actively working, such as time logs or activity monitoring data, can be considered by the model to allocate work effort to those intervals having high-confidence data, and allocate less or no work effort to intervals missing such data.

Even without the presence of high-confidence data, events such as point-in-time changes indicate that an individual is working at least at that time, so can be used to allocate effort to times surrounding those events even if a schedule model indicates that the individual usually does not work during those times.

Any type of input-variable model can be implemented using fixed rules, a machine learning algorithm, or a hybrid between the two. A machine learning (ML) model can be trained using high-confidence data such as work logs and activity monitoring data or direct labels/feedback into the system. An ML model can be used in a hybrid way to compute effort levels for subsets of activity types and intervals based on fixed rules, or it can be used to fully implement the method for computing work effort levels for activity interval inputs.

### 5. Activity Effort Enrichment

Once the methods for computing activity records from event records and then allocating effort based on intervals from those activity records have been applied, the result is a level of effort associated with each activity record.

At this point, some embodiments of the invention may find it desirable to apply a post-processing enrichment step (i.e., block 18 in FIG. 1) to compute more relevant information about the activities based on the level of effort that goes into them and activity metadata. There are many possible types of enrichment that could be performed, and at least one embodiment of the invention does not depend on any particular type of enrichment, but a few useful types of enrichment are listed here.

### A. Time Budget Enrichment

One type of enrichment method is to compare the amount of effort associated with one or more activity intervals to a time budget that is related to a particular task or other activity metadata.

This time budget could be set based on goals, such as limiting the amount of meetings per week. Time budgets may also be derived from other metadata about the activity, such as the number of words written or lines changed in a change set based on how long change sets of that size are expected to take, which may be set by rules or derived from statistical analysis of historical data.

Time budgets could also be set based on estimates for particular work tickets, which could be in the form of work hours or an abstract unit like story points. For estimates not in the same units as the work effort values, the budget could be computed based on statistical analysis of work effort compared to abstract estimates from historical data to establish a desired budget threshold. Time budgets relating to tasks may consider all activity types associated with a task as counting against its budget, or only certain subsets of activity obtained by filtering based on metadata, such as a budget specifically for active work time related to code commits and excluding meetings.

Time budget enrichment methods may output information relating to how much of the input activity effort is within budget or over budget, potentially splitting up inputs into multiple outputs representing within-budget and over-budget activity.

### B. Difficulty Enrichment

After effort levels have been computed for activities, it may be further beneficial to apply an enrichment method to compute a level of efficiency or difficulty for the activity based on the amount of effort and the other metadata.

For example, activity metadata may contain information about the number of words or lines changed as part of a change set. If the amount of effort per unit of change is high, that may indicate a highly difficult activity, versus an activity with a lower effort cost per unit of change.

In another embodiment, the effort levels can be compared to the size of a change set to identify changes that were likely automatically generated or copied because the number of changes is greater than a person could have manually conducted with the given level of effort—for example, composing a 5000-word document in 5 minutes.

These difficulty enrichment method outputs may be used in downstream reports to classify different types of activity. They may also be used to split up activity into multiple intervals based on an inference of how effort was broken up given the effort level and activity metadata. For example, writing activity intervals could be divided into writing time and editing time based on the number of words written, the amount of effort, and a model of writing vs. editing time relative to word count and time spent.

### C. Timing Enrichment

Another enrichment method involves computing some level of efficiency or efficiency penalty related to the timing and/or duration of the activity.

The previous method for allocating effort to time intervals already computes how much effort is consumed by an activity that could have been devoted to something else given that time is largely fungible. However, the effort allocation method is not intended to assess the actual level of productivity realized given the level of effort that was consumed. A timing enrichment method can be applied for this purpose.

It is well known that certain types of activities like writing or developing software require focus and have a ramp-up time during which a person conducting the activity is familiarizing themselves with the task and less productive. Even brief interruptions can disrupt productivity longer than the direct length of the interruption because they can negatively impact working memory associated with a task.

A timing enrichment method may attempt to account for the overhead associated with task ramp-up time, context switching, or any other way that productivity is influenced by the duration or time of day of the work interval.

Timing enrichment methods may generate an output indicating the amount of effort that should be considered overhead associated with ramp-up/ramp-down time or other timing-based inefficiencies for an activity. They may further split up activities into multiple activities representing time spent on the productive portion and the overhead portion of a task.

### 6. Classifying Activity

Following the steps of calculating activity from events, allocating effort to activity time intervals, and optionally post-processing the activity records to enrich them, the next step (i.e., block 20 in FIG. 1) in at least one embodiment of the invention is to apply an activity classification method to those activity records that have data and enriched attributes added to them, which are referred to as enriched activity records.

While the raw information about activity intervals, their respective level of effort, and attributes added by enrichment may be useful on its own in some scenarios, it can be used most effectively and aggregated for reporting when the enriched activity records have a classification method applied to them to that outputs a group key for each record that can be used to aggregate records sharing the same value or filter certain records.

Furthermore, at least one embodiment of the invention may apply multiple classification methods to the activity records for the purposes of displaying data along multiple dimensions in a report, or filtering records having certain values for one classification method.

There are many different ways to classify activity for different purposes and at least one embodiment of the invention does not depend on any particular classification method to function, but here common classification methods and their applications are described.

### 1. Time Period

Activity may be classified into a particular group based on its time period, which is a common way of classifying data. Any size of time period may be used, but common time periods include day, week, month, quarter, year.

### 2. Sprint

Teams that use “sprints” as part of an agile process may want to classify and aggregate activity by sprint to facilitate easy comparison between sprints over time.

### 3. Release/Version

Some teams may use release numbers and versions to demarcate periods of software development instead of or in addition to sprints, and may wish to classify activity by this field.

### 4. Activity Type

One basic way to classify activity is to just group it directly by the type of activity indicated in the activity metadata in the activity record. This activity type may indicate things like: out-of-office, meeting, coding, emailing, etc. The activity type may further be broken down based on other attributes too, like those added during post-processing. For example, coding time could be split into regular coding time and coding time over an estimate-budget.

### 5. Individual, Team, Group

Another dimension that can be used for classification is the identity of the individual who conducted the activity, or any further grouping of multiple individuals, such as by team, division, job role, or other attributes like length of tenure or salary.

### 6. Task Identifier

It may be desirable just to group activity together based on the assigned task identifier to see how much activity is associated with each task.

### 7. Task Type

Another approach to classifying activity is to do it based on the type of task or attributes of the task such as labels. This can be helpful for seeing the amount of activity associated with certain types of work denoted in the task definition, such as bug fixes, refactoring, planning, etc.

### 8. Board or Project

Tasks may be associated with one or more “board” or “project” entities within a project management system, independently of any other fields in the task. The board or project linked to the task identifier in an activity record can be used for classification.

### 9. Task Groups, Epics, Initiatives

Another common idiom in project management/task tracking software is the idea of an “epic” or “initiative.” This is essentially a parent container for a set of tasks, which may in turn be part of a higher-level parent container. Activity may be classified based on the epic or other task grouping associated with the task identifier.

10. Deleted vs. Modified vs. New Code

Attributes associated with code commits indicating the type of changes they represent may also be used for classifying activity. It can be helpful to know how much effort actually goes toward writing new code versus deleting or modifying existing code as an indicator of how difficult existing code is to modify, or of whether developers are actually investing sufficiently in code refactoring in maintenance in alignment with organizational objectives.

### 11. Longevity of Code

Another classification method that may be useful is the longevity of code that was either added or deleted by coding activity. Data relating to when and how much of the code was deleted prior to merging into another branch can indicate the level of “code churn” or rework that occurred for some coding activity. Furthermore, the portion of code that is removed over time after it has been integrated into the main code base can be used to classify coding activity according to its quality—with code that is re-written within a short time frame potentially indicating a high level of bugs or other quality issues.

### 12. Merge/Deployment Status

Coding activity can be traced through version control systems to see which branches it has been integrated into. Furthermore, information from deployment systems can show whether certain code has been released to customers.

It may be helpful to classify coding activity based on whether it has been merged into a common branch, how long it took for that merge to occur, and whether it has been deployed or how long it took for the first deployment to occur.

### 13. Other Code Attributes

Other attributes of code may be useful for classification, such as the programming language or frameworks used by the code. One application of this classification is to track progress toward shifting the amount of activity devoted toward working with lower-quality code by refactoring code in the most highly-used areas.

14. Capital vs. Operational Expenses

One higher-level type of activity classification is whether that activity represents effort that can be capitalized for accounting purposes, or must be classified as an operational expense. There are various rules that dictate the types of activities that may be capitalized, and those rules may be different for complying with generally accepted accounting principles (GAAP) versus computing R&D tax credits.

Capital Expenditure (CapEx) activity classification will infer from one or more attributes or other lower-level classifications like classifying tasks by epic and task type whether the effort that went into a task should be capitalized.

15. Value-Adding vs. Non-Value-Adding

Another higher-level classification method looks at whether the activity should be considered a value-adding activity or a non-value-adding activity. The idea behind this type of classification is that it may be possible to reduce some or all of non-value-adding activities through improvements without detracting from value provided to customers.

For example, on a software engineering team, time spent in certain types of meetings, filling out expense reports, or fixing bugs could be considered non-value-adding.

The output of this type of method also need not be binary and may be a number or limited set of values (e.g., “low”, “medium”, “high”) indicating the amount of value being added by the activity.

The particular way that activities are classified as value-adding or non-value-adding can be defined based on fixed rules derived from domain expertise, or provided by the user of at least one embodiment of the invention as configuration options

16. Velocity-Adding vs. Overhead

Another high-level classification approach is to classify activity based on whether it contributes to the team's “velocity”, or rate of work completed over time as defined by the team.

This type of classification may look at things such as whether or not the task associated with the task identifier was added after the start of a sprint or completed by the end of a sprint. It may also consider time in excess of a time budget derived from a time estimate as going toward overhead rather than adding to velocity. Depending on the desired outcome, indicators of scope creep like tasks that were added to an epic or project in excess of its estimated total size may be used to indicate non-velocity adding activities.

Again, the exact way that activities are classified may be defined based on domain expertise or configured by the user of the system.

### 7. Activity Reporting

After enriched activity records have been classified in some way, they may be presented in step or block 22 of FIG. 1 to a user in the form of a report in a document, website, mobile application or other medium. The results may also be reported by being made available through an application programming interface (API) for consumption by another computer program. This list of delivery methods is meant to be illustrative rather than exhaustive, and the final activity information may be reported in any form.

### A. Data Rollup

This final step of reporting activity involves a first data rollup step, which is analogous to constructing a pivot table from raw data using spreadsheet software. This data rollup step involves aggregating activity across a graph dimension, and optionally grouping by zero or more groups specified by outputs of the classification step. Time period is a commonly used graph dimension, along with other classifications that correlate with time, such as sprints and releases, but any graph dimension could be used.

The data may also be filtered by graph dimension or classification group using standard filtering operators of including or excluding specific values, or using value ranges to specify values that should be included or excluded from the result set.

While any fields in the enriched activity records may be displayed as values, users may commonly want to report aggregate function values such as average, minimum, maximum, standard deviation, or percentile related to one or more of the following for each graph dimension value (i.e., for each time period):
1. Absolute level of effort, such as full-time-equivalent person-effort or person-days
2. Level of effort as a percentage of available effort
3. Total activity time as absolute amount (the aggregate time interval length prior to computing the level of effort)
4. Total activity time as percentage

Furthermore, users may want to report total counts of activity records or distinct counts based on different types of activity metadata properties, such as code commits, pull requests, tickets, individuals.

The output of the data rollup step is a series of rows with columns representing the graph dimension value, additional classification grouping values, and then one column for each desired aggregate value. This output can be expressed in tabular form that can be represented in a spreadsheet, exposed via standard methods for providing tabular data through an API, or provided as input for a software user interface or document graphic (such as a graph in a spreadsheet).

### B. Data Presentation

At least one embodiment of the invention may optionally involve a step of data presentation via a document or user interface. This data presentation step may be skipped if the data is provided via an API or as a plain data file such as CSV file.

Data presentation may be performed via any method of displaying tabular data, such as is available in standard spreadsheet applications. Typically, data will be presented horizontally along the graph dimension (e.g., time period, sprint, release) with different bars for each graph series value derived from the classification.

In addition to these standard data presentations, other presentation methodologies can be used to more effectively convey the specific types of information in at least one embodiment of the invention.

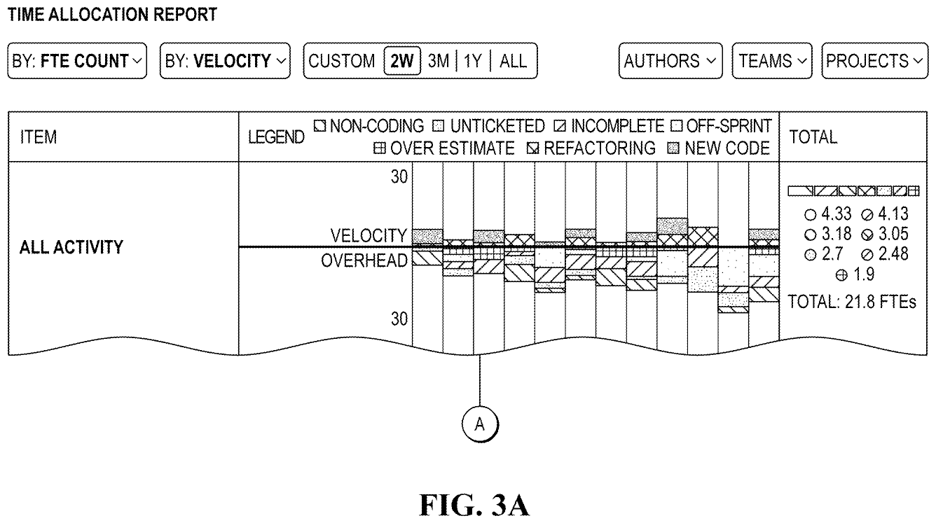

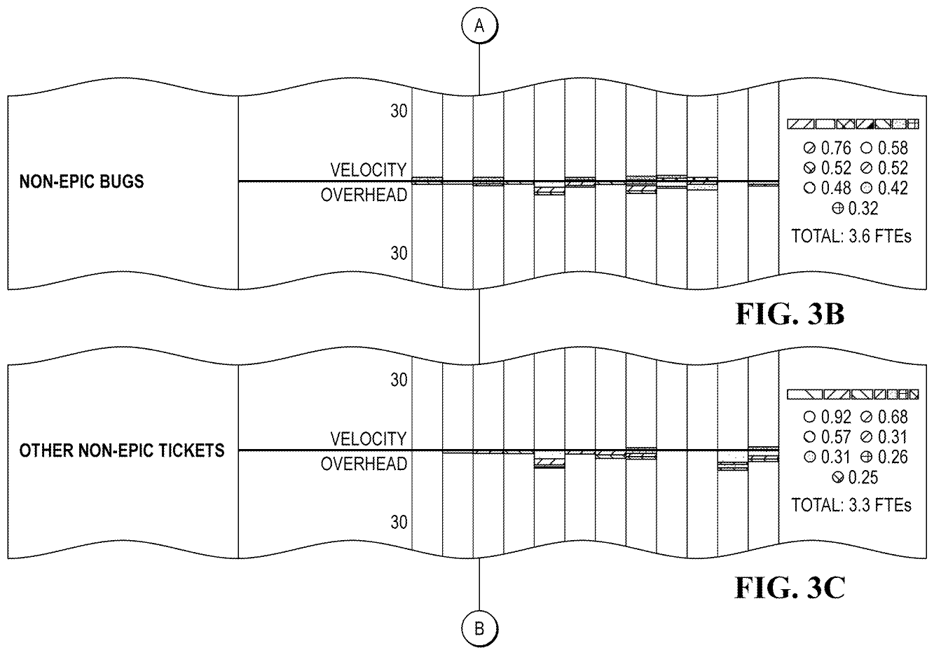

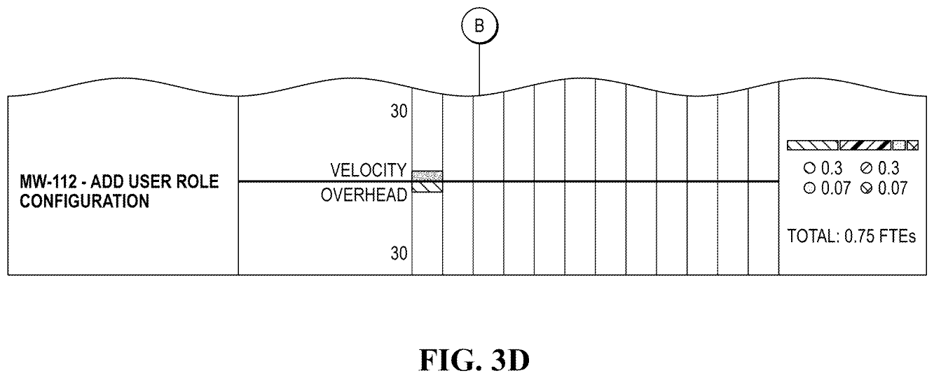

First, it is common that there may be one type of high-level binary classification, such as capital/operating expense, value/non-value, or velocity overhead that would benefit the user to see in addition to a non-binary classification like type of task (e.g., bug, feature, etc.) or activity (e.g., meeting, coding, etc.). FIG. 3A shows a method for achieving this display of two data dimensions on a graph by displaying graph series values having one binary classification value (velocity-adding) above a vertically centered horizontal axis and the other classification value (overhead) beneath the horizontal graph axis so that the user can easily visualize which graph series values belong to each binary classification.

Additionally, it may be useful for the user to view data associated with different classification groups other than the groups used in a primary visualization as seen in the graph legend. To achieve this, one option is to provide a tree user interface that allows visualizing subsets of the data related to particular groups. FIGS. 3B, 3C and 3D show expanding all activity grouped by activity type over time into separate child graphs showing slices of that activity for different task types and different task epics. Epics could then be expanded to show activity for particular tasks, subtasks, etc. The particular classification groups shown in the tree structure could be any groups and at least one embodiment of the invention would work with any manner or depth of tree expansion. These figures are simply meant to illustrate how data from additional classification dimensions can be made easily available in a user interface.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of assessing labor efficiency of knowledge work, the method comprising the steps of:
receiving event data extracted from one or more data sources, the data being related to activities conducted by knowledge workers, to obtain event records, each event record containing the identity of each worker associated with an event, and either a time interval or a point in time when the event occurred;
calculating activity records associated with the time intervals during a time period from the event records, the activity records containing information about what occurred based on the event records; and
allocating work effort based on the time intervals from the activity records to associate a cost with the activities and to obtain an effort value indicating amount of effort for each time interval.

2. The method as claimed in claim 1, further comprising the step of classifying the activity records.

3. The method as claimed in claim 1, further comprising the step of enriching the activity records to compute additional information about the activities based on the level of effort that goes into the activities and activity metadata.

4. The method as claimed in claim 3, further comprising the step of classifying the enriched activity records.

5. The method as claimed in claim 2, further comprising presenting the classified activity records to a user.

6. The method as claimed in claim 5, wherein the classified activity records are presented to a user in the form of a report.

7. The method as claimed in claim 4, wherein the classified enriched activity records are presented to a user.

8. The method as claimed in claim 1, further comprising the step of processing the event data to add or change metadata related to each event to obtain preprocessed event data.

9. The method as claimed in claim 8, wherein the step of calculating activity records is performed with the preprocessed event data.

10. The method as claimed in claim 1, wherein the knowledge work is software development work.

11. A system for assessing labor efficiency of knowledge work, the system comprising:
at least one hardware processor; and
at least one storage device coupled to the at least one hardware processor and for storing instructions that are operable, when executed by the one or more hardware processors to cause the one or more hardware processors to perform operations comprising:
receiving event data extracted from one or more data sources, the data being related to activities conducted by knowledge workers, to obtain event records, each event record containing the identity of each worker associated with an event and either a time interval or a point in time when the event occurred;
calculating activity records associated with time intervals during a time period from the event records, the activity records containing information related to the events that occurred during or near the time intervals; and
allocating work effort based on the time intervals from the activity records to associate a cost with the activities and to obtain an effort value indicating amount of effort for each time interval.

12. The system as claimed in claim 11, further comprising the operation of classifying the activity records.

13. The system as claimed in claim 11, further comprising the operation of enriching the activity records to compute additional information about the activities based on the level of effort that goes into the activities and activity metadata.

14. The system as claimed in claim 13, further comprising the operation of classifying the enriched activity records.

15. The system as claimed in claim 12, further comprising the operation of presenting the classified activity records to a user.

16. The system as claimed in claim 15, wherein the classified activity records are presented to a user in the form of a report.

17. The system as claimed in claim 14, wherein the classified enriched activity records are presented to a user in the form of a report.

18. The system as claimed in claim 11, further comprising the operation of processing the event data to add or change metadata related to each event to obtain preprocessed event data.

19. The system as claimed in claim 18, wherein the operation of producing activity records is performed with the preprocessed event data.

20. The system as claimed in claim 11, wherein the knowledge work is software development work.

21. A computer-readable storage medium storing a program of instructions executable by a machine to perform operations comprising:
receiving event data extracted from one or more data sources, the data being related to activities conducted by knowledge workers to obtain records, each event record containing the identity of each worker associated with an event and either a time interval or a point in time when the event occurred;
calculating activity records associated with time intervals during a time period from the event records, the activity records containing information about what occurred based on the event records; and
allocating work effort based on the time intervals from the activity records to associate a cost with the activities and to obtain an effort value indicating amount of effort for each time interval.

22. The storage medium as claimed in claim 21, wherein the knowledge work is software development work.
